(19) United States
(12) Patent Application Publication
(10) Pub. No.: US 2003/0213528 A1
(43) Pub. Date: Nov. 20, 2003

(54) Device for in-line supplying of additives to a base product, in particular for filling machines, and associated filling machine

(76) Inventor: Cesare Ronchi, Cassina De'Pecchi (IT)

Correspondence Address: WILDMAN, HARROLD, ALLEN & DIXON, 225 WEST WACKER DRIVE, CHICAGO, IL, 60606, US

(21) Appl. No.: 10/434,046

(22) Filed: May 8, 2003

(30) Foreign Application Priority Data
May 14, 2002 (IT) MI2002A 001030

(51) Int. Cl. B65B 43/42; B67C 3/00

(52) U.S. Cl. 141/145

(57) ABSTRACT

Device for supplying additives (A,B,C) and machine for filling containers (4) with a fluid product (6) supplied to delivery heads (5) by means of a header (7;7;107) and distribution ducts (7a;7b) comprising means (10a,10b,10c,11;110A,110B,110C,11) for supplying said additives (A,B,C) to the said header (7;7;107) receiving the base product (6).

The present invention relates to a device for supplying additives to machines for filling containers with a fluid product and an associated filling machine. In the technical sector relating to the packaging of liquid and/or fluid products, so-called filling machines are known, said machines being able to introduce automatically a programmed quantity of product into individual containers which are subsequently sealed and conveyed away for boxing. It is also known that these machines are formed by a circular platform onto which the empty containers are fed and arranged at regular angular intervals so that, by imparting a rotational movement to the platform, said containers are arranged in a coaxial position underneath fixed heads for delivering the quantity of product envisaged for filling the container. It is also known that these delivery heads are connected to supply ducts radially connected to a central header into which the product to be packaged flows.

As a result of this configuration, it is required to prepare different types of finished product before they are supplied to the machine, resulting in considerable storage problems and a reduced flexibility of the machine, which is also subject to a notable downtime due to the need to change over the product storage vessels and the need to perform complicated machine flushing-out operations when the products are changed. Since said products are normally obtained from a base formulation to which suitable additives specifically intended for the particular function of the finished product are added, the problem arises of providing container filling machines in which it is possible to supply a base product with the selective addition of different additives during the continuous operation of the machine.

Within the scope of this problem it is also required that said additives should be able to be added in a selective manner also in relation to different product delivery heads so that, during the same operating cycle, the containers may be filled with different finished products.

In addition, it is required that the devices able to provide a solution to the abovementioned technical problems should be simple and inexpensive to produce and able to be applied easily to machines of the known type without the need for complicated accessories.

This technical problem is solved according to the present invention by a device for supplying additives to machines for filling containers with a fluid product supplied to delivery heads by means of a header and distribution ducts, which comprises means for supplying said additives to the said header receiving the base product.

Further details and characteristic features will emerge clearly from the following description of a non-limiting example of embodiment of the device according to the invention provided with reference to the accompanying figures, in which:

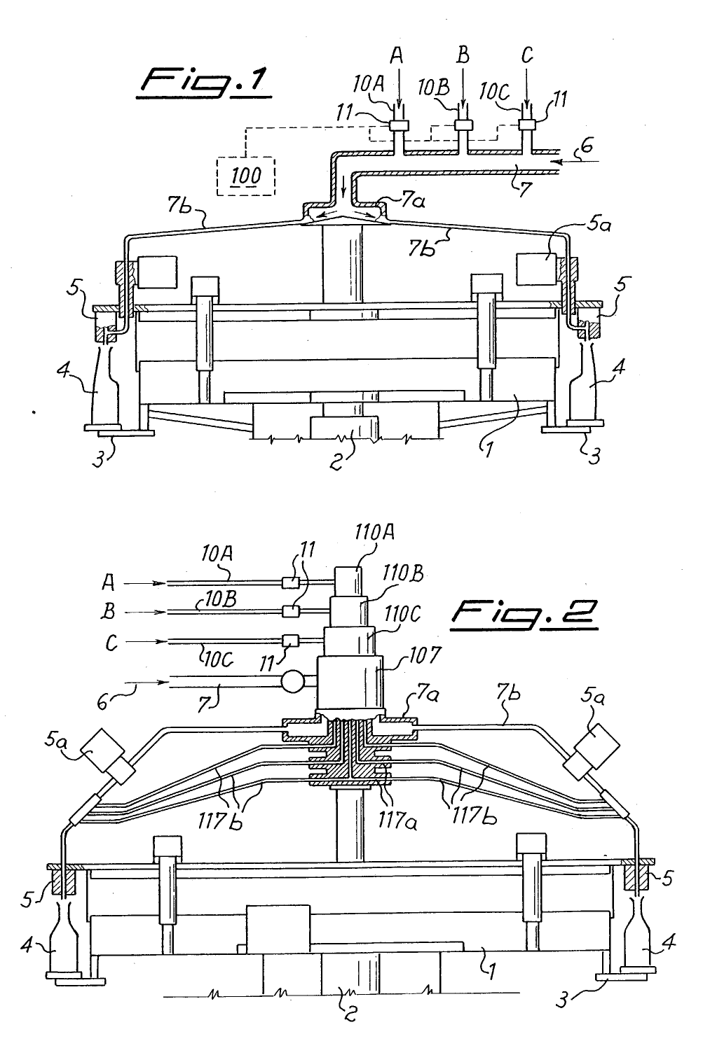

FIG. 1 shows a schematic cross-section, along a vertical plane, through a filling machine with a device for supplying additives according to the present invention; and

FIG. 2 shows a cross-section, similar to that of FIG. 1, of a second example of embodiment of the delivery device according to the present invention.

As illustrated in FIG. 1, a filling machine according to the invention comprises a rotating table 1 actuated by means of coaxial means 2 and having, along its circumferential edge, supports 3 for containers 4 arranged coaxially underneath heads 5 for delivering a fluid 6 supplied by means of a header 7, one end of which enters coaxially into a distributor 7a to which ducts 7b for supplying the product to the heads 5 are radially connected.

Said ducts 7b have, inserted along them, a respective metering device 5a.

According to the invention it is envisaged that one or more ducts 10A,10B,10C for supplying different additives A,B,C are connected along a section of the header 7, which ducts have, inserted along them, a respective valve 11 for opening/closing their apertures.

Said valves 11 may be conveniently of the electromagnetic type which can be remotely operated by means of centralized control and actuating devices which are schematically indicated by 100 in the figures.

With the device for supplying additives according to the present invention it is therefore possible to supply a single base product 6 and a plurality of additives A,B,C independently of each other by means of the selective actuation of said valves 11, so as to determine the final specialization of the product during the filling cycle and upstream of the delivery phase.

The configuration according to FIG. 1 therefore solves the problem posed in a static manner, but with the limitation consisting in the fact that it is not possible to supply selectively different additives A,B,C to different delivery heads 5.

This problem is solved, however, by the second embodiment of the device according to the invention shown in FIG. 2 where, as in the case of FIG. 1, the base product 6 is supplied to the header 7, one end of which enters coaxially into a distributor 7a to which ducts 7b for supplying the product to the heads 5 are radially connected.

The configuration shown in FIG. 2 envisages a section 107 coaxial with the duct 7 for distributing the base fluid and a plurality of tubular elements 110A,110B,110C, respectively, arranged coaxially with the said vertical section 107 of the duct 7 for distributing the base fluid and connected to a respective pipe 10A,10B,10C for supplying a respective additive A,B,C.

On the opposite side to the supplying side, each of said coaxial tubular elements 110A,110B,110C terminates in a respective header 117a to which the first end of a plurality of distribution ducts 117b is connected, the other end thereof being connected to a section of the duct 7b for supplying the base product, arranged upstream of each delivery head 5.

It is thus possible to supply selectively to each head one or other of the additives A,B,C—or combinations thereof—providing, if required, the possibility of differentiating each delivery head 5—or groups of heads—from one another so that each container 4—or groups of containers 4—may be filled with different products.

It is therefore clear how with the device and the filling machine according to the invention it is possible to store large volumes of a single base product 6 and small volumes of the different additives which, since they are added in a small percentage compared to the total weight of the finished product, require a very small storage capacity.

In addition to reducing the problems associated with storage of the base product, the devices and the machine according to the invention are also able to reduce substantially the downtime of the machine resulting from the need to wash it when there is a variation in the additives, it being in fact possible to maintain a large number of different additives always available for supplying to the machine and, in the event of variation of one of them, to wash solely the line supplying that specific additive which is replaced by another one.

1) Device for supplying additives (A,B,C) to machines for filling containers (4) with a fluid product (6) supplied to delivery heads (5) by means of a header (7;7;107) and distribution ducts (7a;7b), characterized in that it comprises means (10a,10b,10c,11; 110A,110B,110C,11) for supplying said additives (A,B,C) to the said header (7;7;107) receiving the base product (6).

2) Device according to claim 1, characterized in that said additive supplying means comprise at least one duct (10A) along which means (11) for intercepting its aperture are arranged in order to close and open it.

3) Device according to claim 2, characterized in that said intercepting means consist of at least one controllable valve (11).

4) Device according to claim 3, characterized in that said at least one controllable valve (11) is connected to programmable actuating means (100).

5) Device according to claim 1, characterized in that said duct (7) supplying the base product (6) comprises a section (107) coaxial with the axis of rotation of the machine.

6) Device according to claim 5, characterized in that said ducts (10A,10B,10C) supplying the respective additives (A,B,C) comprise respective sections (110A,110B,110C) coaxial with the axis of rotation of the machine.

7) Device according to claim 6, characterized in that said respective coaxial sections (110A,110B,110C) of the ducts (10A,10B,10C) supplying the additives (A,B,C) are situated concentrically inside the coaxial section (107) of the duct (7) supplying the base product (6).

8) Device according to claim 6, characterized in that the opposite ends of the coaxial sections (110A,110B,11C) of the additive supplying ducts are respectively connected to an associated duct (10A,10B,10C) for supplying a respective additive (A,B,C) and to a respective distributor (117a).

9) Device according to claim 8, characterized in that a first end of a plurality of pipes (117b) is connected to each of said distributors (117A), the other end thereof being connected to the same delivery head (5).

10) Machine for filling containers (4) with a fluid product (6) supplied to delivery heads (5) by means of a header (7;7,107) and distribution ducts (7a,7b) and comprising a device for supplying additives (A,B,C), characterized in that said device for supplying the additives (A,B,C) is connected to the said header (7;7,107) supplying the base product (6).

11) Machine according to claim 10, characterized in that said device for supplying the additive(s) comprises at least one duct (10A) along which means (11) for intercepting its aperture are arranged in order to open and close it.

12) Machine according to claim 11, characterized in that said intercepting means consist of at least one controllable valve (11).

13) Machine according to claim 12, characterized in that said at least one controllable valve (11) is connected to programmable actuating means (100).

14) Machine according to claim 10, characterized in that said duct (7) supplying the base product (6) comprises a section (107) coaxial with the axis of rotation of the machine.

15) Machine according to claim 14, characterized in that said ducts (10A,10B,10C) supplying the additives (A,B,C) comprise respective sections (110A,110B,110C) coaxial with the axis of rotation of the machine.

16) Machine according to claim 15, characterized in that said respective coaxial sections (110A,110B,110C) of the ducts (10A,10B,10C) supplying the additives are situated concentrically inside the coaxial section (107) of the duct (7) supplying the base product (6).

17) Machine according to claim 15, characterized in that the opposite ends of said coaxial sections (110A,110B,11C) of the ducts supplying the additives are respectively connected to an associated duct (10A,10B,10C) for supplying a respective additive (A,B,C) and to a respective distributor (117a).

18) Machine according to claim 17, characterized in that a first end of a plurality of pipes (117b) is connected to each of said distributors (117A), the other end thereof being connected to the same delivery head (5).
